(19) United States
(12) Patent Application Publication
(10) Pub. No.: US 2021/0397234 A1
(43) Pub. Date: Dec. 23, 2021

(54) SHARING POWER AMONG ELECTRONIC DEVICES CONNECTED BY SERIAL BUS CONNECTIONS

(71) Applicant: HEWLETT-PACKARD DEVELOPMENT COMPANY, L.P., SPRING, TX (US)

(72) Inventors: RICHARD S LIN, SPRING, TX (US); QIJUN CHEN, SPRING, TX (US); ROGER D BENSON, SPRING, TX (US); JON G LLOYD, SPRING, TX (US)

(21) Appl. No.: 16/758,140

(22) PCT Filed: Feb. 7, 2018
(86) PCT No.: PCT/US2018/017179

§ 371 Date: Apr. 22, 2020

(51) Int. Cl. G06F 1/26; G06F 13/42

(52) U.S. Cl. CPC G06F 1/266; H02J 7/02; G06F 13/4282

(57) ABSTRACT

A technique includes determining first power received via a first serial bus connector of the machine; and allocating a second power communicated via a second serial bus connector of the machine based on the determined first power.

### BACKGROUND

A pair of electronic devices (a tablet computer, a laptop computer, an external hard disk drive (HDD), a monitor, and so forth) may be physically connected to each other by a serial bus cable, such as a Universal Serial Bus (USB) cable. For purposes of data communications between the electronic devices, one of the electronic devices is a host (which initiates the data communication), and the other electronic device is a peripheral. The USB Power Delivery (PD) Specification sets forth a standard for electronic devices to negotiate power delivery so that one of the devices (the receiver) receives power from the USB cable, and the other device (the contributor) provides the power from the USB cable. When the electronic devices become first connected to the USB cable, the devices may negotiate to create a PD contract, which establishes which of the devices is the contributor and which device is the receiver. Moreover, the PD contract allocates a certain level of power from the contributor.

### BRIEF DESCRIPTION OF THE DRAWINGS

FIGS. 1 and 2 are schematic diagrams of power ecosystems according to example implementations.

FIG. 3 is a flow diagram depicting a technique performed by a first electronic device in response to a second electronic device connecting to a Universal Serial Bus (USB) port connector of the first electronic device according to an example implementation.

FIG. 4 is a state diagram depicting active power sharing control by an electronic device according to an example implementation.

FIG. 5 is a state diagram depicting reactive power sharing control by an electronic device according to an example implementation.

FIG. 6 is a flow diagram depicting a technique to share power among first, second and third electronic devices via serial bus connections according to an example implementation.

FIG. 7 is an illustration of a non-transitory machine readable storage medium storing machine executable instructions that, when executed by a machine, cause the machine to allocate a power communicated over a serial bus connector of the machine according to an example implementation.

FIG. 8 is a schematic diagram of an apparatus to control power communicated between the apparatus and an electronic device according to an example implementation.

### DETAILED DESCRIPTION

Multiple electronic devices (laptops, tablet computers, smartphones, desktop computers, and so forth) may be connected together through serial bus connections. For example, in accordance with example implementations, three or more electronic devices may have Universal Serial Bus (USB) port connectors such that electronic device A may be connected by a USB cable to electronic device B, and electronic device A may also be connected (through another USB connector) to electronic device C. Moreover, the electronic devices may each have Power Delivery (PD) capability, which permits a given electronic device to either contribute power to another electronic device or receive power from another electronic device via a USB connection with that device. In this manner, the USB PD specification allows devices that are connected by USB-A or USB-C cables to negotiate a power sharing contract, or agreement, between the two devices. In this manner, through this PD negotiated contract between two such USB connected devices, one of the electronic devices is the power source, or “contributor,” and the other electronic device is the power sink, or “receiver.” Moreover, the PD contract defines a maximum amount of power that may be provided by the contributor to the receiver.

In accordance with example implementations that are described herein, three or more electronic devices, which are connected by serial bus port connectors (connected by USB port connectors and corresponding USB cables, for example) may form a power sharing agreement that defines power allocations for each of the electronic devices. The collective power sharing agreement takes into account the total power sourced to each electronic device, as well as the total power load of each device. For example, electronic device A may receive power over a USB cable from electronic B, and electronic device A may provide power to electronic device C. The total power sourced to electronic device A may be a summation of the power received from electronic B and the power provided by the battery of electronic device A. The total power load of electronic device A may be the summation of power load of components of electronic device A as well as the power provided by electronic device A to electronic device C.

In accordance with example implementations, a plurality of electronic devices may be interconnected with each other through their USB port connectors to form a power ecosystem. A given electronic device may, upon connection of another electronic device to the USB port connector of the given electronic device, communicate with the other electronic devices for purposes of determining contributor/receiver roles for the USB port connectors of the power ecosystem and for purposes of allocating power loads for the electronic devices of the power ecosystem.

As a member of the power ecosystem, a given electronic device may monitor its power load and implement a reactive power sharing control or an active power sharing control. When using the reactive power sharing control, an electronic device may react to a power demand increase in the device's power load by communicating with a contributor to increase power to the electronic device or communicating with a receiver to swap roles and become a contributor of power to the electronic device. If this is unsuccessful, the reactive power sharing control may involve the electronic device reducing the power consumed by its components by power throttling.

When using active power sharing control, an electronic device may react to a power demand increase in the device's power load by first employing power throttling to reduce the power that is consumed by its components. If the power throttling results in unsatisfactory performance, the electronic device may then communicate with a contributor to increase power to the electronic device and/or communicate with a receiver to swap roles and become a contributor of power to the electronic device. If the power demand has still not been met, the electronic device may use the power throttling until the power demand is reduced (regardless of performance).

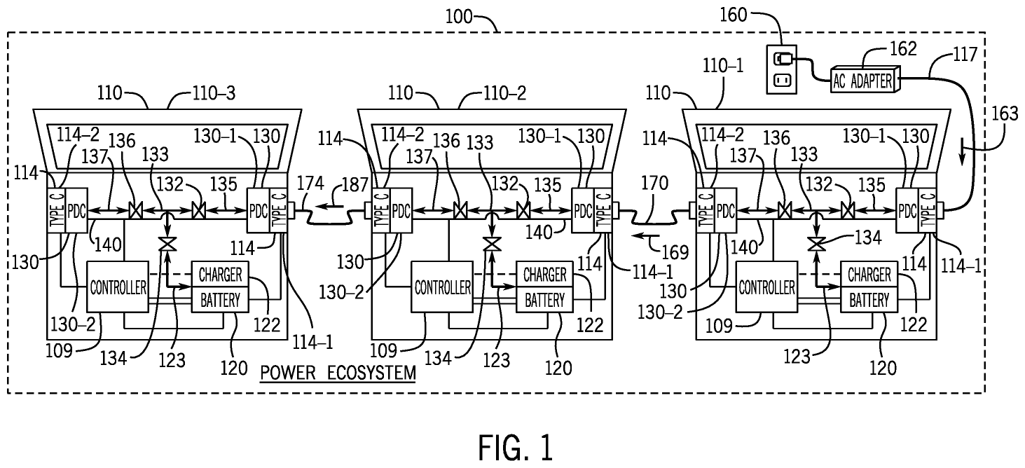

FIG. 1 depicts an example power ecosystem 100 in accordance with some implementations. The power ecosystem 100 includes laptop computers 110 (three example laptop computers 110-1, 110-2 and 110-3, being depicted in FIG. 1), which are connected together for purposes of sharing power and data through USB cables. For purposes of simplifying the following discussion, it is assume that the electronic devices of the power ecosystem 100 are laptop computers 110, and moreover, it is assume that laptop computers 110 have similar components (denoted by the same reference numerals). However, the power ecosystem 100 may have electronic devices other than laptop computers, and moreover the laptop computers may have different components and may be associated with different manufacturers, in accordance with example implementations.

For the exemplary power ecosystem 100, each laptop computer 110 includes one or multiple type C USB port connectors 114 (two type C USB port connectors 114-1 and 114-2 being depicted in FIG. 1 for each laptop computer 110); and each USB port connector 114 is associated with and connected to a power delivery (PD) controller 130. In FIG. 1, each laptop computer 110 includes a PD controller 130-1 (connected to and associated with the USB port connector 114-1) and a PD controller 130-2 (connected to and associated with the USB port connector 114-2). In this context, the “PD controller” refers to a physical interface with the associated USB port connector (i.e., the drivers and receivers to generate and receive USB signals) as well as a controller to negotiate PD over the associated USB connector.

The laptop computer 110-1 receives power from an AC wall receptacle 160. In this regard, an AC adapter 162 for this example is plugged into the AC wall receptacle 160 and is connected to a type-C USB cable 117, which, in turn, is connected to the USB port connector 114-1. For this specific example, the USB port connector 114-1 receives power from the AC adapter 162, and correspondingly, the PD controller 130-1 does not negotiate power. Instead, power flows, as depicted by arrow 163, from the AC adapter 162 into the laptop computer 110-1.

As schematically depicted in FIG. 1, the laptop computer 110-1 has control points 132, 134 and 136, which control the flow of power between the USB port connector 114-1, another USB type-C port connector 114-2 of the laptop computer 110-1, and an internal battery 120 of the laptop computer 110-1. In this manner, as depicted at bidirectional arrow 123 of FIG. 1, depending on whether the battery 120 is being charged or sourcing power, power may flow to or from the battery 120. Moreover, a charger 122 may be used to condition the power for the battery 120 when power is flowing to the battery 120.

Moreover, as depicted by bidirectional arrows 133, 135 and 137, there are numerous bidirectional paths for power to flow within the laptop computer 110-1. In this manner, power may flow from the AC adapter 162 to charge the battery 120, power may flow to power consuming components of the laptop computer 110-1 and power may flow to the other USB port connector 114-2. Moreover, the laptop computer 110-1 may have more than two USB port connectors 114, and each of these ports 114 may, for example, be associated with and connected to a PD controller. In this manner, in accordance with example implementations, each USB port connector 114 (such as USB port connectors 114-1 and 114-2, for example) may receive power from another electronic device, receive power from a power source or provide power to another electronic device.

For the configuration that is depicted in FIG. 1, the laptop computer 110-1 is a power receiver at the USB port connector 114-1, as the laptop computer 110-1 receives power from the AC adapter 162. At the USB port connector 114-2, the laptop computer 110-1 may either be a power contributor or a power receiver, depending on a number of factors (the power consumed by the components of the laptop computer 110-1, the charge capacity of the battery 120, and so forth).

The USB port connector 114-2 of the laptop computer 110-1 is connected by a USB cable 170 to the USB port connector 114-1 of the laptop computer 110-2. For the example state of the power ecosystem 100 of FIG. 1, at USB port connector 114-2 of the laptop computer 110-1 is a power contributor, the USB port connector 114-1 of the laptop computer 110-2 is a power receiver, and as such, power flows in direction 169 along the USB cable 170. Moreover, the USB port connector 114-2 of the laptop computer 110-2 is connected by a USB cable 174 to the USB port connector 114-1 of the laptop computer 110-3. For the example state of the power ecosystem 100 of FIG. 1, at USB port connector 114-2 of the laptop computer 110-2 is a power contributor, the USB port connector 114-1 of the laptop computer 110-3 is a power receiver, and as such, power flows in direction 187 along the USB cable 174.

It is noted that depending on the power sources available to the laptop computer 110-2 the power roles of the USB port connectors 114 of the laptop computer 110-2 may change. For example, the battery 120 of the laptop computer 110-2 may become depleted, and as such, the laptop computer 110-2 may not receive sufficient power from the USB cable 170 to sustain the power load of the laptop computer 110-2 (i.e., the load due to the power consuming components of the laptop computer 110-2 and the power supplied through USB cable 174 to the laptop computer 110-3). As such, as described herein, corrective action may be taken, such as, as examples, the laptop computer 110-2 performing power throttling to reduce the power demanded by its components; the laptop computer 110-2 requesting an increase in the power supplied by the laptop computer 110-1; the laptop computer 110-2 initiating a swap in power roles in which the USB port connector 114-1 of the laptop computer 110-3 becomes the power provider, and the USB port connector 114-2 of the laptop computer 110-2 becomes the power receiver; and so forth.

In accordance with example implementations, the laptop computer 110 contains a controller 109 that regulates power sharing for the case in which the laptop computer 110 is connected to multiple other electronic devices through USB connections, i.e., for the scenario in which the laptop computer 110 and other electronic devices to form a power ecosystem. Depending on the particular implementation, the controller 109 may be an inter-integrated circuit (I²C) controller or a microcontroller unit (MCU). In this manner, in accordance with some implementations, the controller 109 may include a processor, such as a processor formed from one or multiple central processing unit (CPUs), one or multiple CPU cores, and so forth. In accordance with example implementations, the processor may execute machine executable instructions (or “software”), which are stored in a memory of the controller 109 for purpose of causing the controller 109 to perform one or more of the techniques that are described herein. The memory may be a non-transitory storage medium that is formed from storage devices, such as semiconductor storage devices, memristors, phase change memory devices, volatile memory devices, non-volatile memory devices, memory devices from other storage technologies, one or more of the foregoing storage devices, and so forth.

In accordance with further example implementations, the controller 109 may be formed from one or multiple hardware circuits that do not execute machine executable instructions. In this regard, in accordance with further example implementations, in place of a processor executing instructions, for example, the controller may include one or multiple hardware circuits, such as a field programmable gate array (FPGA), an application specific integrated circuit (ASIC), and so forth.

Regardless of its particular form, in accordance with example implementations, the controller 109 may perform the following in response to the laptop computer 110 containing the controller 109, such as laptop computer 110-2, being connected to at least one other electronic device through USB connection(s). The controller 109 may communicate (via an I²C bus 140, for example) with the PD controllers 130-1 and 130-2 of the laptop computer 110-2 for purposes of determining the power status of the laptop computer 110-2, i.e., the incoming power received by the laptop computer 110-2 and the outgoing power provided by the laptop computer 110-2. As an example, the PD controllers 130-1 and 130-2 may include current sensors, which allows the PD controllers 130-1 and 130-2 to sense these powers. The controller 109 of the laptop computer 110-2 may also communicate with the controllers 109 of the laptop computers 110-1 and 110-3 for purposes of determine the power statuses of the laptop computers 110-1 and 110-3.

From this information, the controller 109 of the laptop computer 110-2 may determine the power roles of the USB port connectors 114-1 and 114-2 of the laptop computer 110-2, i.e., determine whether the USB port connector 114-1 of the laptop computer 110-2 is a power receiver or contributor and determine whether the USB port connector 114-2 of the laptop computer 110-2 is a power receiver or contributor. For example, if the controller 109 determines, based on the power statuses, that the power provided by the USB cable 170 and the power available from the battery 120 of the laptop computer 110-2 is sufficient to power both laptop connectors 110-2 and 110-3, then the controller 109 sets up the USB power roles so that power flows between the laptop computers 110-1, 110-2 and 110-3, as depicted in FIG. 1. As another example, if the controller 109 determines that the power that is supplied by the USB cable 170 and the power that is available from the battery 120 of the laptop computer 110-2 is not sufficient or marginally sufficient to supply power to the power consuming components of the laptop computer 110-2, then the controller 109 may set up the USB power roles so that the USB cable 174 and the USB cable 170 provide power to the laptop computer 110-2.

It is noted that the power ecosystem 100 is advantageous over, for example, the unconstrained power provision in the USB PD specification, as the unconstrained power may eventually stifle any available power at the end of multiple receiver tier connections. To the contrary, the power ecosystem 100 may allow accumulated total power from all contributor systems throughout the entire power system for any power delivery direction.

FIG. 2 depicts an example power ecosystem 200 in accordance with further example implementations. For this example, the power ecosystem 200 includes four laptop computers 110 (i.e., laptop computers 110-4, 110-5, 110-6 and 110-7), which are connected by USB cables to form a power grid to supply power among the laptop computers 110. For this example implementation, an electronic device 210 that is constructed to receive and not provide power, such as a smartphone, is connected to the laptop computer 110-7. Moreover, for the power ecosystem 200, more than one electronic device is connected to an AC wall power source. In this regard, for the power ecosystem 200, the laptop computer 110-4 is connected by a USB cable 230 to receive power (as indicated by arrow 231) from an AC wall-based adapter 224 that is connected to an AC wall receptacle 220; and the laptop computer 110-6 is connected to an AC adapter 260 that receives power from an AC wall-based adapter 260 that is connected with an AC wall receptacle 262.

For the state of the power ecosystem 200 depicted in FIG. 2, power flows in one direction from the laptop computer 110-4 (one end of the power chain) to the other end of the chain, i.e., the smartphone 210. In this manner power flows in direction 241 from the laptop computer 110-4 to the laptop computer 110-5 via USB cable 240; in direction 248 from the laptop computer 110-5 to the laptop computer 110-6 via USB cable 244; in direction 253 from the laptop computer 110-6 to the laptop computer 110-7 via USB cable 250; and in direction 255 from the laptop computer 110-7 to the smartphone 210 via USB cable 255 that connects to USB port 211 of the smartphone 210.

FIG. 2 illustrates power contracts that may be established due to USB PD negotiations that occur between the controllers 109 (see FIG. 1) of pairs of the laptop computers 110 when the computers 110 are connected by USB cables. In accordance with example implementations, as further described herein, although the PD negotiations may establish an initial power contract and power roles associated with a particular USB cable connection, the controller 109 of a given laptop computer 110 may override the power contract and change the power roles for purpose of regulating power sharing between the laptop computer 110 and other electronic devices. For the example implementation depicted in FIG. 2, the USB cable connections between the pairs of laptop computers 110 are associated with power contracts 243, 245 and 251 that have associated 45 Watt (W) power levels and power roles as shown. Moreover, the USB cable connection between the laptop computer 110-7 and the smartphone 210 has an associated 15 W power level. As described further herein, in accordance with some implementations, the PD controller 130 for a given laptop computer 110 may request the maximum available power from the power contributor(s) that furnish power to the given laptop computer 110.

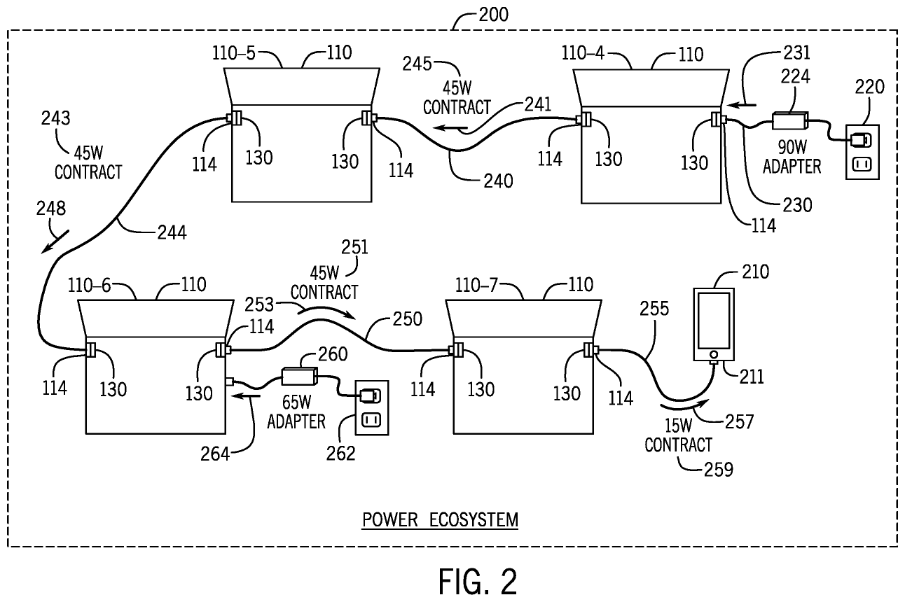

In accordance with example implementations, when a first electronic device (such as the laptop computer 110) connects through its USB port connector to a second electronic device (such as another laptop computer 110), the first electronic device may perform a technique 300 that is depicted in FIG. 3. Referring to FIG. 3 in conjunction with FIG. 1, the technique 300 includes the controller 109 of the first electronic device setting up an initial power contract with the second electronic device per a Type C Power Management (TCPM) policy for the first electronic device. Therefore, at this point, PD negotiation may have occurred to establish the power level and power roles. Pursuant to block 314, the controller 109 may then determine the power status of the first electronic device (the total power load of the first electronic device, including the power consumed by the components of the first electronic device and the power provided to other electronic device(s), for example) and communicate with the controller 109 of the second electronic device to determine the power status of the second electronic device (the power that the second electronic device is capable of delivering over the USB connection, for example). Based on this information, the controllers 109 of the first and second electronic devices may then set up contributor and receiver power roles, pursuant to block 318.

If the first electronic device is to receive power from the second electronic device, then, in accordance with example implementations, the controller 109 of the first electronic device requests (block 326) the highest available power level from the second electronic device. The controller 109 regulates power sharing based on the load of the first electronic device, pursuant to block 330.

Referring back to FIG. 1, when two laptop computers 110 are connected to each other via their USB ports to share power via a USB cable, one of the laptop computers 110 furnishes power to the USB cable and is referred to herein as performing the role of “contributor,” and the other laptop computer 110 receives power from the USB cable and is referred to herein as performing the role of “receiver.” A given laptop computer 110 may be, for example, a contributor for one of its USB connections and a receiver for another USB connection. Moreover, the roles of a pair of laptop computers 110 that share power over a given USB cable may swap, as further described herein.

For the following discussion, it is assumed that for the power sharing that occurs over the USB cable 170, the laptop computer 110-1 is at least initially the contributor, and the laptop computer 110-2 is at least initially the receiver (i.e., the laptop computer 110-2 receives power from the laptop computer 110-1 via the USB cable 170). Moreover, for the following discussion, it is assumed for the power sharing that occurs over the USB cable 174, the laptop computer 110-2 is at least initially the contributor, and the laptop computer 110-3 is at least initially the receiver (i.e., the laptop computer 110-3 receives power from the laptop computer 110-2 via the USB cable 174).

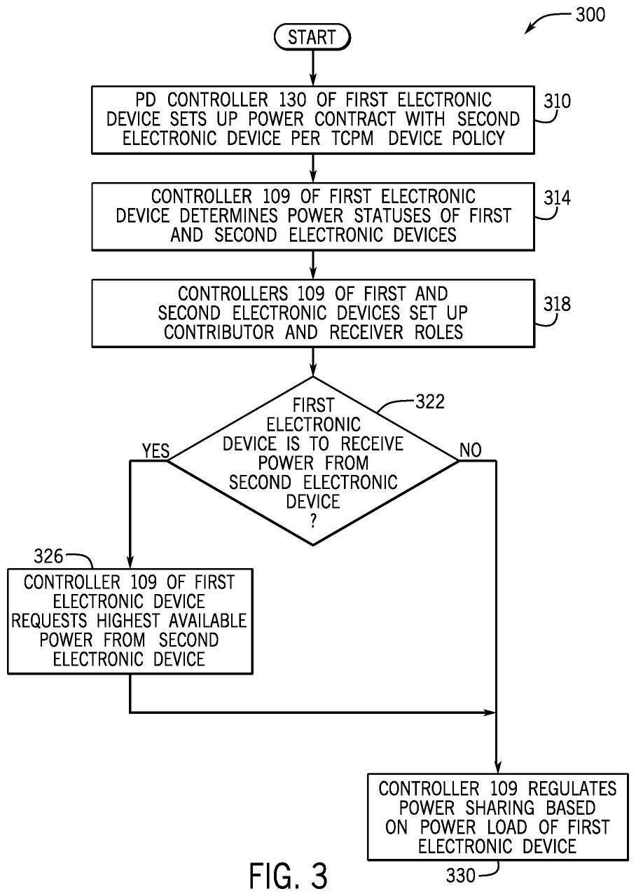

Referring to FIG. 4 in conjunction with FIG. 1, in accordance with example implementations, the controller 109 of the laptop computer 110-2 may use a reactive approach to control the power sharing. In particular, the controller 109 of the laptop computer 110-2 may control the power sharing pursuant to a state diagram 400 of FIG. 4. The controller 109 continually monitors (state 410) the power load of the laptop computer 110-2, so that when the controller 109 detects a power demand increase, as depicted at reference number 411, the controller 109 may transition to state 414. It is noted that, in accordance with example implementations, the controller 109 may detect a power demand increase by communicating with the PD controllers 130-1 and 130-2 (see FIG. 1) of the laptop computer 110-2 to determine when the power demand for the laptop computer 110-2 has increased. In accordance with some implementations, the controller 109 may deem an increase to have occurred in response to the total power demand of the laptop computer 110-2 increases beyond a threshold power demand (the power demand when the power sharing began with the laptop computer 110-2 or a certain percentage above the power demand when the power sharing began, for example).

In the state 414, the controller 109 of the laptop computer 110-2 (the receiver for the power sharing over the USB cable 170) sends a message to the controller 109 of the laptop computer 110-1 (the contributor for the power sharing over the USB cable 170) requesting a power increase. If the power increase meets the power demand of the laptop computer 110-2, as depicted at reference number 415, then the controller 109 of the laptop computer 110-2 returns to the state 410. However, as depicted at reference number 417, if the power increase from the contributor is not enough to meet the power demand increase (or perhaps if the contributor cannot increase power), then the controller 109 transitions to state 418, in which the controller 109 sends a message to the controller 109 of the laptop computer 110-3 (the receiver for the power sharing over the USB cable 174) for the laptop computers 110-2 and 110-3 to swap roles for the power sharing over the USB cable 174. With this power role swap, the laptop computer 110-3 is now the contributor and the laptop computer 110-2 is now the receiver for the power sharing over the USB cable 174. In other words, with the power role swap, another contributor is now providing power to the laptop computer 110-2, and if the controller 109 of the laptop computer 110-2 determines that the power increase meets the demand, then the controller 109 of laptop computer 110-2 transitions back to the state 410.

If, however, the controller 109 of laptop computer 110-2 determines, as depicted at reference number 419, that the power from the new contributor (laptop computer 110-3) is not sufficient to meet the power demand, then the controller 109 may transition to a state 428 in which the controller 109 throttles power of the laptop computer 110-2. For example, in accordance with some implementations, the controller 109 may use configurable thermal design power (cTDP) throttling, in which the controller 109 downwardly adjust the thermal design power (TDP) value of one or multiple microprocessors of the electronic device to downwardly adjust their operating frequencies (and consequently decrease the power demand of the electronic device). In response to the power reduction meeting the demand increase, the controller 109 may then transition back to state 410.

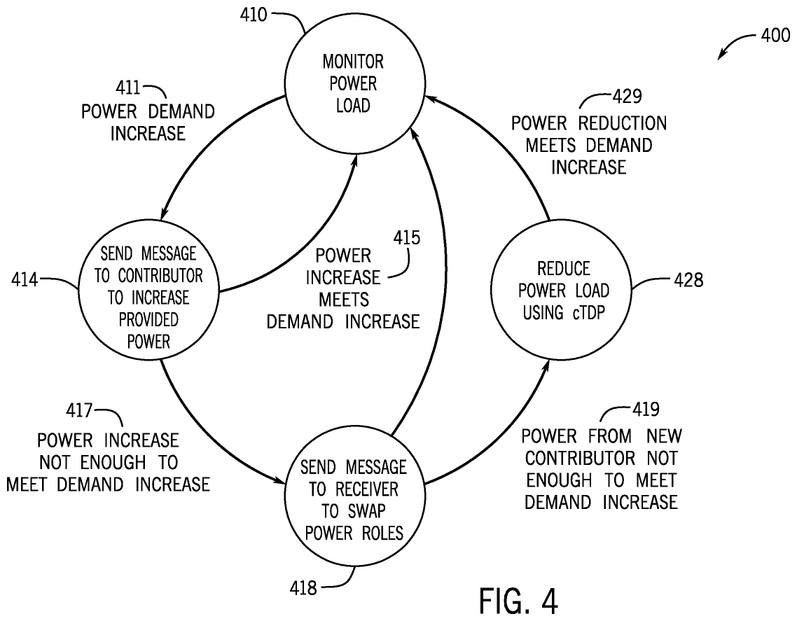

FIG. 5 depicts a state diagram 500 for an example implementation in which the controller 109 of laptop computer 110-2 (FIG. 1) actively controls the power sharing. Referring to FIG. 5 in conjunction with FIG. 1, it is assumed for this example that initially, the laptop computer 110-2 is the receiver and contributor for the power sharing that occurs over the USB cables 170 and 174, respectively. Pursuant to the state diagram 500, the controller 109 of the laptop computer 110-2, in a state 506, sets up power limits and monitors power loading. When a power demand increase is detected, as depicted at reference number 507, the controller 109 of the laptop computer 110-2 transitions to a state 510 in which the controller 109 reduces power of the laptop computer 110-2 by throttling until the power demand increase is offset. In this manner, the throttling may involve cTDP throttling. If the power throttling meets the power demand increase without resulting in an insufficient performance of the electronic device, as depicted at reference number 512, then the controller 109 of the laptop computer 110-2 transitions back to the state 506. Evaluating the performance of the laptop computer 110-2 may involve the controller 109 of the laptop computer 110-2 determining whether one or multiple metrics of the laptop computer 110-2 meet predefined thresholds, such as metrics that measure access times, latencies, throughputs, processor utilizations, and so forth, of the electronic device.

If the controller 109 of the laptop computer 110-2 determines that the performance of the laptop computer 110-2 is insufficient after the power throttling, then, as depicted at block 514, control may transition to block 514, in which the controller 109 sends a message to the power contributor, laptop computer 110-1, to increase the level of provided power to the laptop computer 110-2. If the controller 109 of the laptop computer 110-2 determines that the additional power meets the demand increase and restores performance to an acceptable level, then the controller 109 transitions back to the state 506, as depicted at reference number 519. However, if the controller 109 of the laptop computer 110-2 determines, as depicted in reference number 515, that the additional power is not enough to meet the demand increase, then the controller 109 transitions to a state 518.

In state 518, the controller 109 sends a message to the receiver laptop computer 110-3 for the laptop computers 110-2 and 110-3 to swap power roles, i.e., the laptop computer 110-3 becomes the contributor for the power sharing over the USB cable 174, and the laptop computer 110-2 becomes the receiver. In other words, with this power role swap, another contributor is now providing power to the laptop computer 110-2, and if the power increase meets the demand, then the controller 109 of the laptop computer 110-2 transitions back to the state 506. Otherwise, from the new contributor is not sufficient to meet the demand increase, then, as depicted at reference number 521, the controller 109 of the laptop computer 110-2 transitions to a state 522 in which the controller 109 reduces power using power throttling (cTDP-based throttling, for example). When the throttling results the power demand increase being met, then, as depicted at reference number 523, the controller 109 of the laptop computer 110-2 transitions back to the state 506.

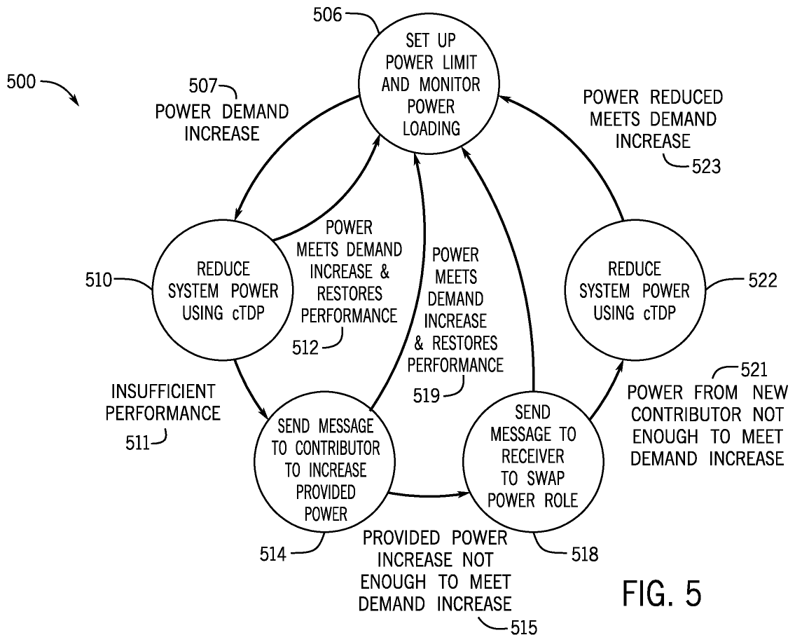

Referring to FIG. 6, in accordance with example implementations, a technique 600 includes a first electronic device connecting (block 604) with a second electronic device via a first serial bus connection; and the first electronic device connecting (block 608) with a third electronic device via a second serial bus connection. The technique 600 includes the first electronic device determining (block 612) power statuses of the first, second and third electronic devices; and the first electronic device determining (block 616) roles of the first, second and third electronic devices in power grid (that includes the first, second and third electronic devices) based on the power statuses.

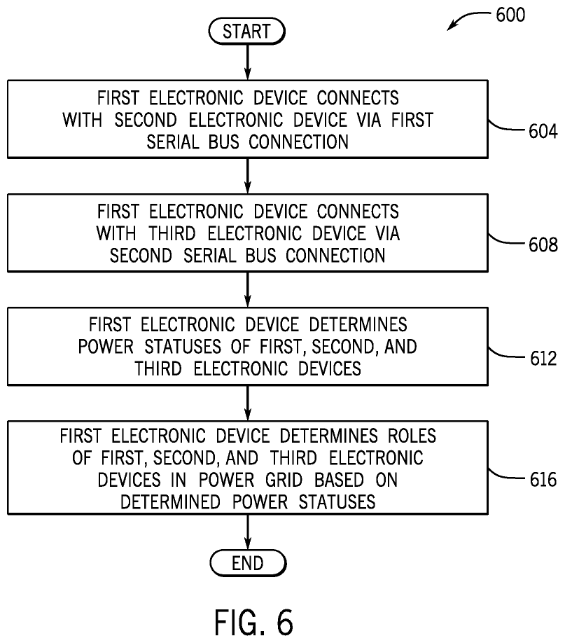

Referring to FIG. 7, in accordance with example implementations, a non-transitory machine readable storage medium 700 stores instructions 710 that, when executed by a machine, cause the machine to determine a first power that is available via a first serial bus connector of the machine and allocate a second power communicated via a second serial bus connector of the machine based on the determined first power.

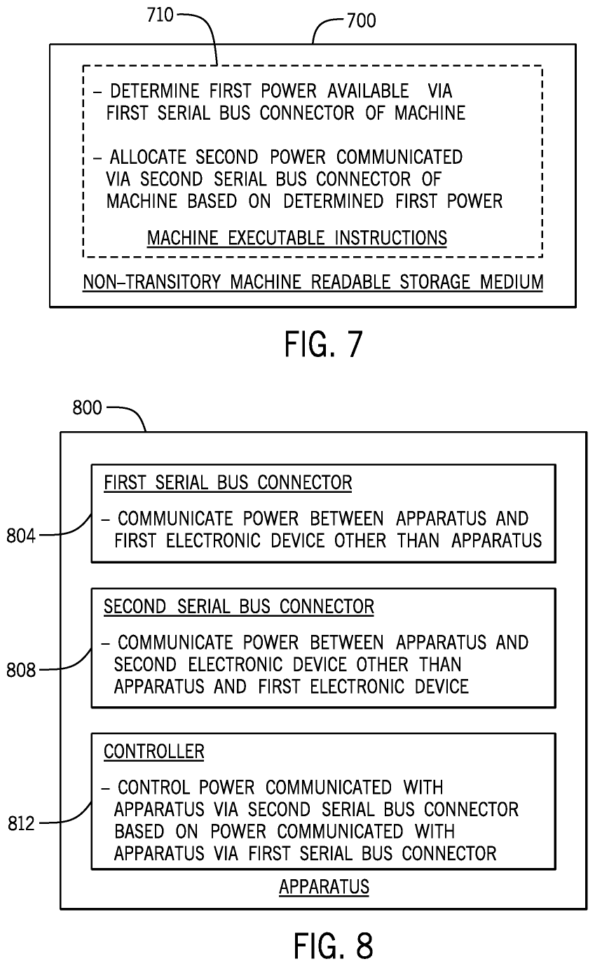

Referring to FIG. 8, in accordance with example implementations, an apparatus 800 includes a first serial bus connector 804, a second serial bus connector 808 and a controller 812. The first serial bus connector 804 communicates power between the apparatus 800 and a first electronic device other than the apparatus. The second serial bus connector 808 communicates power between the apparatus 800 and a second electronic device other than the apparatus 800 and the first electronic device. The controller 812 controls power communicated between the apparatus 800 via the second serial bus connector based on the power communicated between the apparatus 800 via the second serial bus connector 804.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
a first electronic device connecting to a second electronic device via a first serial bus connection;
the first electronic device connecting to a third electronic device via a second serial bus connection with the third electronic device;
the first electronic device determining power statuses of the first, second and third electronic; and
the first electronic device determining roles of the first, second and third electronic devices in a grid based on the determined power statuses.

2. The method of claim 1, wherein the first electronic device determining the power statuses comprise the first electronic device communicating with power delivery controllers of the first electronic device.

3. The method of claim 1, wherein the first electronic device determining the power statuses comprise the first electronic device communicating with the second and third electronic devices via the first and second serial buses.

4. The method of claim 1, further comprising the first electronic device controlling power sharing among of the power grid by the first, second and third electronic devices based on a power demand of the first electronic device.

5. The method of claim 1, further comprising:
the first electronic device detecting an increase in a power demand associated with the first electronic device; and
the first electronic device communicating with the third electronic device to request the third electronic device to increase the power provided by the third electronic device to the first electronic device based on the detected increase.

6. The method of claim 5, further comprising:
the first electronic device reducing a power consumed by the first electronic device in response to the third electronic device not increasing the power to offset the detected increase.

7. The method of claim 5, further comprising:
the first electronic device communicating with the second electronic device to request the second electronic device to reverse power roles and become a power contributor to provide power to the first electronic device via the first serial bus connection in response to the third electronic device not increasing the power to offset the detected increase.

8. The method of claim 1, further comprising:
the first electronic device detecting an increase in a power demand associated with the first electronic device; and
the first electronic device performing power throttling to detected increase in the power demand.

9. The method of claim 8, further comprising:
the first electronic device communicating with the third electronic device to request the third electronic device to increase the power provided by the third electronic device to the first electronic device based on a performance of the first electronic device after performing the power throttling.

10. A non-transitory machine readable storage medium to store instructions that, when executed by a machine, cause the machine to:
determine a first power received via a first serial bus connector of the machine; and
allocate a second power communicated via a second serial bus connector of the machine based on the determined first power.

11. The non-transitory machine readable storage medium of claim 10, wherein the storage medium stores instructions that, when executed by the machine, cause the machine to determine a third power available from a battery of the machine; and
further base the allocation of the second power based on the determined third power.

12. The non-transitory machine readable storage medium of claim 10, wherein the instructions to cause the machine to allocate the second power communicated over the second serial bus connector comprise instructions that, when executed by the machine, cause the machine to determine a power sourced by the machine via the second serial bus connector.

13. An apparatus comprising:
a first serial bus connector to communicate power with a first electronic device;
a second serial bus connector to communicate power with a second electronic device; and
a controller to control the power communicated between the apparatus and the second electronic device via the second serial bus connector based on power communicated between the apparatus and the first electronic device via the second serial bus connector.

14. The apparatus of claim 13, wherein the controller controls power received via the second serial bus connector based on power communicated via the first serial bus connector.

15. The apparatus of claim 13, wherein the controller controls power communicated via the first serial bus connector based on the power communicated via the second serial bus connector.
